(19) United States
(12) Patent Application Publication
(10) Pub. No.: US 2026/0004135 A1
(43) Pub. Date: Jan. 1, 2026

(54) DATA ANALYSIS PIPELINE ENGINE IN A DATA INTELLIGENCE SYSTEM

(71) Applicant: Microsoft Technology Licensing, LLC, Redmond, WA (US)

(72) Inventors: Melissa AILEM, Los Angeles, CA (US); Max Piasevoli, New York, NY (US); Srisuma Movva, Seattle, WA (US); William Blum, Bellevue, WA (US); Daniel Lee Mace, Bellevue, WA (US); Homa Hayatyfar, Seattle, WA (US)

(21) Appl. No.: 18/759,847

(22) Filed: Jun. 29, 2024

(51) Int. Cl. G06N 3/088; G06F 21/56; G06N 3/0455

(52) U.S. Cl. CPC G06N 3/088; G06F 21/56; G06N 3/0455; G06F 2221/034

(57) ABSTRACT

Methods, systems, and computer storage media for providing a data analysis pipeline using a data analysis pipeline engine in a data intelligence system are described. A data analysis pipeline refers to a structured sequence of data processing steps that support transforming raw data into meaningful insights or actionable outcomes. The data analysis pipeline engine is an unsupervised learning pipeline based on clustering, topic modeling, and Large Language Models (LLMs). For example, the data analysis pipeline can use advanced machine learning techniques to automatically categorize emails into semantically similar clusters, enabling the data intelligence system to quickly identify and prioritize potentially high-risk emails for further investigation. The data analysis pipeline employs AI agents for context-aware graph induction relevance assessment. The AI agents employ induction and deduction loops to build and refine a data feature hypergraph (e.g., vulnerability hypergraph) that encompasses identified relevant data providing a holistic view of a contextual landscape.

### BACKGROUND

Users rely on computing systems to analyze vast amounts of data, derive insights, and make informed decisions. A data intelligence system refers to sophisticated platform design to collect, process, analyze, and present data to help user make informed decisions. In particular, the data intelligence system may integrate various data sources, employ advanced analytics, and provide actionable insights through intuitive visualizations and report tools. For example, a data intelligence system can support visualizing trends, patterns, and anomalies. The data intelligence can enable real-time monitoring, predictive analytics and comprehensive reporting, enhancing strategic planning and operational efficiency across a wide range of domains from cybersecurity to healthcare.

### SUMMARY

Various aspects of the technology described herein are generally directed to systems, methods, and computer storage media for, among other things, providing a data analysis pipeline. The data analysis pipeline is implemented using a data analysis pipeline engine in a data intelligence system. A data analysis pipeline refers to a structured sequence of data processing steps that support transforming raw data into meaningful insights or actionable outcomes. The data analysis pipeline engine is an unsupervised learning pipeline based on clustering, topic modeling, and Large Language Models (LLMs) to help security analysts efficiently and effectively dissect large scale datasets (e.g., security data). For example, the dataset can be an email corpus with emails that are undergoing security analysis. The data analysis can provide explainable analysis of the breadth and content that encompasses a large volume of emails. The data analysis pipeline can use advanced machine learning techniques to automatically categorize emails into semantically similar clusters, enabling a data intelligence system to quickly identify and prioritize potentially high-risk emails for further investigation. In particular, the data analysis pipeline combines advanced clustering algorithms, topic modeling, and the power of large language models' analysis to dissect and analyze data items of a dataset. For example, for emails in a cybersecurity context, the data analysis pipeline facilitates evaluating security risks of emails for different types of cybersecurity incidents. In this way, security analysts using the data intelligence system can efficiently focus their attention on critical threats (e.g., high-risk emails) enabling timely mitigation actions to safeguard organizational data and resources.

Additionally, the data analysis pipeline employs AI agents for context-aware graph and data feature assessment. For security operations associated with emails, the data feature assessment can be a vulnerability risk assessment in order to ensure the security and integrity of an organization's digital assets. The data analysis pipeline operates with AI agents that are specifically tailored for graph-based reasoning and inference via a reasoned knowledge graph to conduct a comprehensive data feature analysis (e.g., vulnerability risk analysis). The AI agents are specialized or have domain knowledge for graph-based reasoning. The AI agents employ induction and deduction loops to build and refine a data feature hypergraph (e.g., a vulnerability hypergraph) that encompasses identified relevant data providing a holistic view of a contextual landscape. For example, the data analysis pipeline provides for a nuanced and comprehensive understanding of risks associated with each vulnerability identified in a vulnerability hypergraph and their interrelations within a larger infrastructure.

Conventionally, data intelligence systems are not configured with comprehensive logic and infrastructure to provide an adequate and efficient data analysis pipeline. Data intelligence systems operate based on vast amounts of datasets that include human-readable content that is both structured and semi-structured, making it too large for a machine learning models (e.g., large language models (LLM) to process the datasets in their entirety. It is necessary to summarize and categorize unstructured data into coherent clusters to enable comprehension and analysis of vast amounts of information. Processing large datasets without clustering, topic modeling, or graph-based data relevance assessment leads to several limitations: reduced accuracy, inability to handle complexity, data quality issues, scalability problems, inflexibility to new data, and poor optimization. These issues collectively hinder the effectiveness, accuracy, and scalability of data analysis. Processing large datasets in one go can be computationally intensive and may not scale well. A data analysis pipeline built on an integrated knowledge discovery platform enables interdisciplinary semantic analysis to provide improved scalability and efficiency.

A technical solution—to the limitations of conventional data intelligence systems—can include providing data analysis pipeline resources via a data analysis pipeline engine that employs interdisciplinary semantic analysis (e.g., clustering, topic modeling, or graph-based data relevance assessment) for collaborative and holistic data processing and analysis to uncover meaningful patterns and relationships. The data analysis pipeline includes two main frameworks designed to enhance the analysis of data (e.g., unstructured textual data) for managing extensive data volumes. The first framework includes a clustering and topic modeling pipeline to detect and identify instructive clusters (e.g., risky clusters) and narrow down their search for data feature analysis. For example, the clustering and topic modeling pipeline framework assists security analysts in detecting risky clusters for performing vulnerability analysis on the risky clusters. Upon identifying instructive clusters, the second framework relies an agentic framework of AI agents (e.g., Reversible Jump Markov Chain and LLM agents) for graph-based reasoning and inference. For example, after detecting high risk clusters, the AI agent can perform graph-based reasoning to enable thorough vulnerability risk analysis.

In operation, in a first embodiment, a data instance comprising data items is accessed. The data instance is associated with a dataset. A plurality of data item embeddings for the data items in the data instance are generated. The dimensionality of the plurality data item embeddings are reduced. Using one or more unsupervised clustering techniques and plurality of data item embeddings having reduced dimensions, a plurality of instructive clusters associated with the data instance are generated. Using a topic modeling technique, a topic annotation is generated for each of the plurality of instructive clusters. Using one or more large language models and the plurality of instructive clusters with topic annotations, a plurality of annotated clusters are generated. An annotated cluster comprises a category annotation and a summary annotation. A data analysis pipeline output comprising a data instance assessment is generated.

In a second embodiment, a data instance comprising data items is accessed. The data instance is associated with a dataset. Using one or more unsupervised clustering techniques, a plurality of instructive clusters associated with the data instance are generated. Using a topic modeling technique, a topic annotation is generated for each of the plurality of instructive clusters. Using one or more large language models and the plurality of instructive clusters with topic annotations, a plurality of annotated clusters are generated. An annotated cluster comprises a category annotation and a summary annotation. A first data analysis pipeline output comprising a first data instance assessment is generated. The plurality of instructive clusters are filtered based on a filtering criteria comprising a representative data feature parameter. A reasoned knowledge graph is generated based on the filtered plurality of instructive clusters. A second data analysis pipeline output comprising a second data instance assessment is generated. A merged data analysis pipeline output is generated based on the first data analysis pipeline output and the second data analysis pipeline output.

In a third embodiment, a data instance comprising data items is accessed. The data instance is associated with a dataset. Using one or more unsupervised clustering techniques, a plurality of instructive clusters associated with the data instance are generated. The plurality of instructive clusters are filtered based on a filtering criteria comprising a representative data feature parameter. Using a plurality of artificial intelligence agents, a reasoned knowledge graph is generated based on the plurality of instructive clusters. A data analysis pipeline output comprising a data instance assessment is generated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1C are block diagrams of an exemplary data intelligence system including a data analysis pipeline engine, in accordance with aspects of the technology described herein;

FIGS. 2A-2B are block diagrams associated with an exemplary data intelligence system including a data analysis pipeline engine, in accordance with aspects of the technology described herein;

FIG. 3 provides a first exemplary method of providing iterative data processing optimization using a data analysis pipeline engine, in accordance with aspects of the technology described herein;

FIG. 4 provides a second exemplary method of providing iterative data processing optimization using a data analysis pipeline engine, in accordance with aspects of the technology described herein;

FIG. 5 provides a third exemplary method of providing iterative data processing optimization using a data analysis pipeline engine, in accordance with aspects of the technology described herein;

FIG. 6 provides a block diagram of an exemplary data intelligence system suitable for use in implementing aspects of the technology described herein; and

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

A data intelligence system provides a platform or framework designed to collect, process, analyze, and interpret large volumes of data from various sources to derive actionable insights and support decision-making processes. Data intelligence systems often utilize advanced technologies such as artificial intelligence, machine learning, natural language processing, and data visualization techniques to uncover patterns, trends, correlations, and anomalies within the data. By way of illustration, in cybersecurity, a data intelligence system monitors and analyzes network traffic, system logs, and other data sources to detect and respond to security threats. It uses advanced algorithms to identify suspicious activities, such as unauthorized access attempts or malware infections, and provides real-time alerts to security teams. By correlating data from multiple sources, it can uncover complex attack patterns and help organizations strengthen their defenses.

In a legal discovery context, a data intelligence system sifts through vast amounts of electronic documents, emails, and other digital records to find relevant information for legal proceedings. It employs machine learning and natural language processing techniques to identify key documents, extract important facts and relationships, and categorize information according to legal requirements. This helps legal teams streamline the discovery process, reduce costs, and ensure compliance with legal obligations. As such, data intelligence systems enable informed decision-making, provides a competitive edge, manages risks, enhances efficiency, improves customer experiences, reduces costs, ensures regulatory compliance, fosters innovation, and drives growth.

Conventionally, data intelligence systems are not configured with comprehensive logic and infrastructure to provide an adequate and efficient data analysis pipeline. Data intelligence systems process vast amounts of datasets that include human-readable content that is both structured and semi-structured, making it too large for machine learning models (e.g., large language models-LLM) to process the datasets in their entirety. In particular, data analysis for large amounts of data is done using fixed analysis fixed analysis and domain specific rules to analyze, triage, and summarize the data to understand the breadth and depth of relevant data and impact. In addition, conventional data intelligence systems lack the capacity to fully integrate and contextualize the vast amounts of data necessary for a thorough relevant assessment, potentially leaving out critical documents.

Current data intelligence systems, while indispensable for analyzing large datasets, face significant challenges in fully integrating and contextualizing the vast amounts of data necessary for comprehensive assessments. Integration poses a major hurdle as these systems must reconcile diverse data formats and sources, often resulting in gaps or inconsistencies in the analysis. Moreover, contextualization, which is vital for accurate insights, remains a challenge as existing data intelligence systems struggle to grasp nuanced contexts such as the relationships between data points or the historical patterns underlying them. With the exponential growth of data, these data intelligence systems also grapple with processing and analyzing massive volumes of information efficiently and effectively. Consequently, despite their capabilities, they may fail to provide thorough assessments. In the case of risk assessment for vulnerable emails within a corpus, this deficiency could mean overlooking crucial indicators of security threats, potentially exposing organizations to cyberattacks or other security breaches. As such, a more comprehensive data intelligence system—with an alternative basis for performing data intelligence operations—can improve computing operations and interfaces in data intelligence systems.

### DESCRIPTION OF TECHNICAL SOLUTION

At a high level, the data analysis pipeline engine is an unsupervised learning pipeline based on clustering, topic modeling, and Large Language Models (LLMs) to help security analysts efficiently and effectively dissect large scale datasets (e.g., security data)). A dataset refers to a structured collection of organized information used for analysis, research, or other purposes. A data item refers to an individual unit of data in a dataset, which can vary widely in format and content. In one context, a data item can refer to an individual email or data items may include structured data or unstructured data associated with the email. Structured data can include as sender, recipient, timestamp, and subject line, which are organized in a predefined format and easily processed by algorithms. Conversely, unstructured data items within the dataset refer to the email bodies themselves, which contain free-form text and lack a predefined structure, making them more challenging to analyze without preprocessing techniques like natural language processing. Together, structured and unstructured data items in a dataset provide a comprehensive view of the information being studied, enabling insights and decision-making across diverse domains. An unsupervised learning pipeline refers to series of computational steps designed to analyze and extract patterns from data without predefined labels or target outputs. An unsupervised learning pipeline can include data preprocessing, dimensionality reduction techniques and clustering uncover hidden structures or relationships within the data. The pipeline concludes with evaluating and interpreting the results to gain insights or make decisions based on the discovered patterns.

Clustering techniques are used to generate instructive clusters. Instructive clusters refer to distinct groups or categories of data items that can help in understanding the underlying structure or relationships present in the data. Data items in an instructive cluster share similar characteristics or patterns as identified by clustering techniques. Instructive clusters serve to illustrate a meaningful grouping of data items based on their intrinsic properties, such as features or attributes. Topic modeling can be employed to generate topic annotations. A topic annotation refers to a concise summary of the main themes or subjects identified within a cluster of documents or data items. A topic annotation can include a list of top words or terms that are statistically significant and representative of the underlying topic. These top words can be selected based on their frequency within the documents in the cluster and their ability to distinguish the cluster from others in the dataset. As such, topic modelling is used to extract a list of top words that succinctly captures the most relevant and significant terms within a dataset. This helps in understanding the predominant themes or subjects across the dataset.

Additionally, topic modeling enables the creation of extractive summaries, which distill essential information by selecting representative data items (e.g., a set of n representative emails) that encapsulate each identified cluster's content. Moreover, leveraging Large Language Models (LLMs) allows for more advanced capabilities like categorizing content and generating concise, informative summaries that highlight key insights and facilitate deeper understanding of the analyzed data. The LLMs are used to generate annotated clusters that include a category annotation (e.g., risk categorization) and a summary annotation (e.g., abstractive summarization).

An annotated cluster refers to cluster that includes group of data items that have been categorized and summarized by a language model, such as a Large Language Model (LLM). This categorization and summarization are achieved through automated processes that leverage the model's ability to understand and process natural language.

A category annotation refers to a label or category each cluster and/or data item within the cluster based on its content or characteristics. For instance, in risk categorization, data items may be labeled as high, medium, or low risk based on their content or attributes. The category annotation provides a structured classification that helps organize and prioritize the data items according to predefined criteria.

A summary annotation refers to a concise summary or abstract for each cluster and/or data item within the cluster. These summaries capture the essential information or main points of the content, enabling quick understanding and decision-making. Summary annotations can be abstractive, where the language model generates new sentences to summarize the content, or extractive, where key sentences or phrases from the original text are selected and presented as the summary.

Together, these annotations provided by LLMs enhance the usability and accessibility of clustered data by categorizing them into meaningful groups and providing succinct summaries that highlight important information. This capability supports various applications, including content organization, risk assessment, information retrieval, and knowledge discovery in large datasets.

The data analysis pipeline includes support for the following: data embedding computations; dimensionality reduction using UMAP (Uniform Manifold Approximation and Projection); clustering on lower-dimensional space using unsupervised clustering algorithms (e.g., Hierarchical Density-Based Spatial Clustering of Applications with Noise-HDBSCAN and Spherical k-means); topic modeling using transformers and class-based Term Frequency-Inverse Document Frequency (e.g., BERTopic); and using LLMs to generate cluster annotations (e.g., categorizing clusters and generating summaries of clusters). The data analysis pipeline is described below with reference to an unstructured textual dataset (i.e., email dataset) analyzed for vulnerabilities in a cybersecurity context. However, the data analysis pipeline engine is versatile and can be applied to different large scale textual datasets.

As an initial step, the data analysis pipeline accesses a dataset with data items and generates data item embeddings (“embeddings”). A data item embedding refers to a compact numerical representation of a data item, typically in the form of a vector of real numbers. A data item embedding captures the essential characteristics and relationships of the data item, preserving semantic meanings and patterns. Embeddings, generally, in machine learning refer to techniques that represent objects or features as vectors of numerical values. This representation preserves semantic relationships and patterns between the objects or features, enabling machine learning models to effectively learn from and generalize across data In particular, text data embeddings computations involve transforming textual information into numerical representations, typically using techniques like Word2Vec (Word to Vector), GloVe (GloVe (Global Vectors for Word Representation) or BERT (Bidirectional Encoder Representations from Transformers). These computations leverage deep learning and natural language processing algorithms to capture semantic relationships and contextual information, enabling the encoding of words or documents into dense, high-dimensional vectors suitable for machine learning tasks. For example, email embeddings can be generated from an email corpus using advanced embedding models. An email embedding refers to a numerical representation of an email's content, typically in the form of a vector of real numbers. The email embedding captures the semantic meaning and contextual information within the email text, allowing machine learning models to process and analyze emails effectively. Other types of embeddings include image embeddings, where visual features are represented as vectors to facilitate tasks like image classification or object detection. Similarly, graph embeddings encode graph structures into vector representations, aiding tasks such as link prediction or node classification in network analysis.

Dimensionality reduction with UMAP is performed on the embeddings. Dimensionality reduction using UMAP involves transforming high-dimensional data into a lower-dimensional space while preserving the underlying structure and relationships between data points. UMAP utilizes a manifold learning approach, which focuses on capturing the intrinsic geometric properties of the data, enabling it to create compact and meaningful representations suitable for visualization and analysis. Reducing the dimensionality of the data enables applying unsupervised clustering algorithms to identify dense regions and assign data points to clusters in the reduced space, which helps in discovering meaningful patterns and structures in high-dimensional data efficiently. This approach offers a powerful means of clustering in situations where the original data space is too complex or high-dimensional for traditional clustering methods to handle effectively.

The data analysis pipeline employs unsupervised clustering algorithms (e.g., HDBSCAN—Hierarchical Density-Based Spatial Clustering of Applications with Noise, and Spherical k-means clustering) for clustering functionality. For example, a data intelligence system for cybersecurity can employ unsupervised clustering algorithms to target high-risk emails and narrow down the search scope from millions of emails to a few relevant clusters. HDBSCAN extends the traditional DBSCAN (Density-Based Spatial Clustering of Applications with Noise) algorithm by allowing clusters to have varying densities and hierarchical structures. HDBSCAN identifies clusters in high-dimensional data by focusing on regions of high density while automatically determining the number of clusters and handling noise effectively. This algorithm is particularly useful for discovering clusters of varying shapes and densities in datasets with noise and outliers.

Spherical k-means clustering is a variant of the traditional k-means algorithm designed specifically for data represented as vectors on a hypersphere, such as unit vectors or normalized feature vectors. Unlike traditional k-means, which operates in Euclidean space, spherical k-means calculates distances between points on the hypersphere using angular measures (e.g., cosine similarity). This approach ensures that clusters are formed based on directionality rather than magnitude, making it suitable for tasks like text clustering, document classification, and recommendation systems where the magnitude of features is less relevant than their orientation. The unsupervised clustering algorithms can process large datasets effectively. For example, HDBSCAN does not require a predetermined number of clusters and is particularly effective at identifying clusters of varying densities, making it superior for analyzing the diverse nature of email data. Spherical k-means complements this by clustering text data based on spherical distance metrics, which is ideal for the high-dimensional space of text embeddings. The unsupervised clustering techniques can generate cluster labels, where cluster label refers to the assignment of each data item to a specific cluster or group based on the inherent structure and similarity within the dataset, without using predefined class labels or targets. Each cluster label identifies which cluster a particular data point belongs to, facilitating the interpretation and analysis of the clustering results.

Topic modeling techniques can be employed to extract topics from each cluster. Topic modeling includes generating top words of each cluster and representative data items of each cluster. A topic modeling technique refers to a statistical technique used in natural language processing and machine learning to discover abstract topics or themes within a collection of documents. A topic modeling technique can operate under an assumption that each document is a mixture of a small number of topics, and each word's presence is attributable to one of the documents topics. Topic modelling can be performed based on BERTopic—a topic technique designed specifically for topic modeling in text data (e.g., capturing topics of each instructive cluster). BERTopic leverages BERT (Bidirectional Encoder Representations from Transformers), a powerful language representation model, to embed documents into high-dimensional vector space. Extracting topics can be based on a class-based TF-IDF (Term Frequency-Inverse Document Frequency) matrix. A class TF-IDF matrix refers to a TF-IDF matrix created specifically for documents belonging to a particular class or category. Topic modeling using BERTopic involves leveraging BERT embeddings to represent text data. This approach allows for more accurate and interpretable topic extraction from text data compared to traditional methods, making it particularly useful for tasks such as document summarization and categorization. In this way, the data analysis pipeline first performs clustering with HDBSCAN and Spherical k-means and then clustering labels of the clusters are fed into BERTopic to obtain topics of each instructive cluster.

Topic modeling can further employ seed words that are specifically chosen to represent specific topics or themes within a corpus of text data. These seed words serve as the initial input or guidance for the topic modeling algorithm, helping it identify and extract coherent topics from the text. The integration of seed words is a distinctive feature that provides a tailored analysis relevant to concerns associated with the dataset. In other words, domain-specific words are prioritized with higher weights and are more frequently featured in topic representations using the BERTopic c_tf_idf method. This method serves as the foundational representation in BERTopic, where each topic is depicted as a bag of words. By leveraging this approach, the data analysis pipeline can highlight the significance of specific security-related keywords, such as “vulnerability.” During the computation of the c-TF-IDF matrix, the scores assigned to these seed words are multiplied by 2 or more, thereby enhancing their chances of being recognized as key words.

Additionally, each cluster will be associated with a concise list of data items (i.e., extractive summary) that best represent it. For example, each email cluster may have a list of emails that are representative of the emails in the cluster. An LLM can be used to generate abstractive summaries and data feature assessments for each cluster. For example, abstractive summaries and risk assessments can be generated for each email cluster using LLMs. This use of LLMs provides additional insight into the content of the cluster facilitating decision making based on the abstractive summaries and data feature assessments. With the dataset segmented into clusters of data items, all data items in each cluster undergo a data feature assessment (e.g., risk assessment). Each data item is scored and prioritized based on predefined categories that the LLM populates after data item content scanning. This dual-layered approach enables a more targeted and efficient analysis, ensuring that most relevant data items (e.g., high-risk emails) are identified swiftly. In email security, this enhances the capability to mitigate potential security breach, and the synergy of ML and AI can transform email risk management into a predictive, proactive approach for investigative post-breach trend analysis.

Using induction-deduction technique associated with a plurality of artificial intelligence (AI) agents (e.g., a Reflexion agent and Recursive Jump Markov Chain and LLM—RJ-MC-LLM agents) the data analysis pipeline can build a reasoned knowledge graph. A Reflexion agent is a computational entity within an AI system that possesses the ability to introspect and monitor its own internal processes, fostering self-awareness and metacognitive reasoning. It enables the agent to adapt its behavior based on insights gained from evaluating its own cognitive processes and performance. A Recursive Jump Markov Chain (RJMC) is a stochastic process that extends the traditional Markov chain framework by allowing transitions not only between adjacent states but also by “jumping” directly to states that are further away in the state space. This jumping behavior is typically governed by a recursive rule or mechanism, which determines the probability of transitioning to a distant state based on the current state of the chain.

The reasoned knowledge graph encapsulates the idea of both inference and reasoning for graph data based on indicating a logical justification or explanation based on careful consideration and inference from available cluster-based analysis output. For example, the data analysis pipeline can generate vulnerability graphs for risk assessment and downstream triage and analysis. The data analysis pipeline leverages AI agents such that the reasoned knowledge graph is generated without having to rely on predefine ontologies or formalized knowledge structures; without having to manage and handle intricate systems or frameworks that are extensive in size and complexity; and with the capacity to effectively handle and represent information that is ambiguous, incomplete, or subject to varying degrees of certainty. In this way, a using Reflexion and RJ-MC LLM dual agent-based framework the data analysis pipeline is capable of processing any unstructured, structured, or semi-structured data into a core set of knowledge components that can be integrated into the enriched reasoned knowledge graph (e.g., vulnerability hypergraph) in a way that does not require a strict ontology. The data analysis pipeline is further capable of handling large, structured, complex data objects. Reasoned knowledge graphs can scale to incorporate hundreds of thousands of nodes and edges, which can be handled by both the validation set of the Reflexion agent and the reversible jump mechanics of the RJ-MC-LLM agent). And, the data analysis pipeline is capable of processing ambiguous information that has varying levels of uncertainty. In particular, the RJ-MC-LLM is capable of ingesting, processing, and updating knowledge as new information is incorporated—and potentially updated to remove in later iteration.

An induction-deduction technique can include an induction step associated with a logical process where specific instances or observations are used to formulate general principles or hypotheses. It involves reasoning from particular facts to broader conclusions. The deduction step can start with general principles or theories and applies them to specific instances to draw conclusions or predictions. As such, iterative loops and refinements are done based on data features and data signals (e.g., vulnerability and other risk signals) to reason over and induct a scoped targeted graph for downstream analysis. The reasoned knowledge graph can be used for further downstream analysis, such as multi-agent data search to understand risks and perform hunting and threat analysis. PageRank and similar analysis can be used to rank data features (e.g., vulnerabilities based on graph relationships). For example vulnerabilities can be ranked and the weighed against internal risks to come up with a new weighted risk. A graph-cut community detection algorithm can be employed to partition the reasoned knowledge graph into clusters by iteratively splitting or merging nodes based on minimizing a predefined criterion, such as modularity, to identify densely connected communities. For example, the graph-cut community detection algorithm can be run to analyze and determine the weak vulnerabilities in an organization, and isolate key nodes in the graph.

Data analysis pipeline output can be generated from the plurality of annotated clusters or using the reasoned knowledge graph associated with plurality of instructive clusters. A merged data analysis pipeline output can be generated from the plurality of annotated clusters and using the reasoned knowledge graph associated with plurality of instructive clusters. The data analysis pipeline output refers to output from incorporating the annotation clusters—indicating group characteristics or insights—and/or a reasoned knowledge graph—depicting logical connections or justifications for findings—into an structured evaluation system (i.e., an assessment framework). An assessment framework provides a structured approach or set of guidelines used to evaluate or measure performance, progress, or effectiveness in a particular domain or context, providing a systematic way to assess various aspects of a system, process, or entity.

A data instance assessment associated with the data analysis pipeline output refers to an evaluation of an individual data instance from the dataset based on their specific attributes and contextual relevance within the analysis framework. This process ensures that each data instance meets assessment standards (e.g., risk assessment, vulnerability). By conducting these assessments, analysts can validate the integrity of data used in generating insights and support informed decision-making processes effectively. Integration facilitates systematic evaluation of cluster characteristics and the reasoning behind insights derived from the data analysis. It supports informed decision-making and enhances the framework's ability to assess and interpret data-driven outcomes effectively.

### Example Systems and Resources

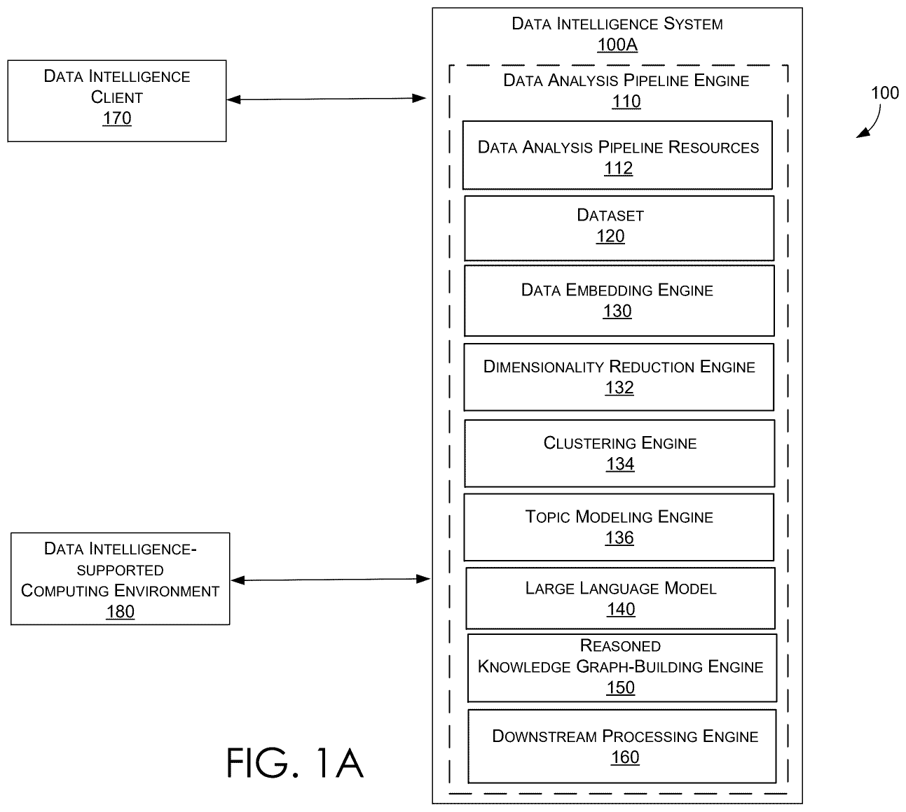

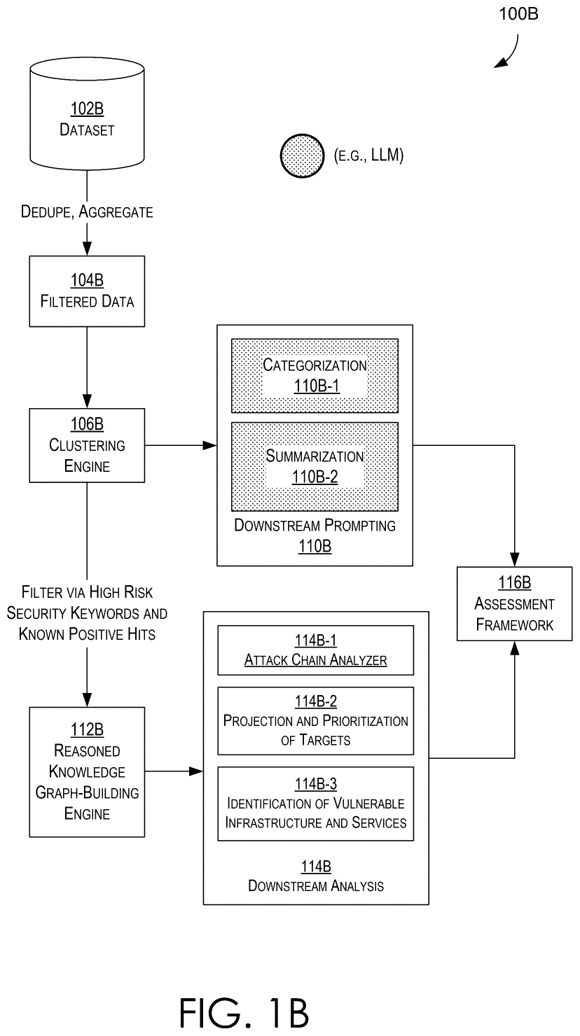

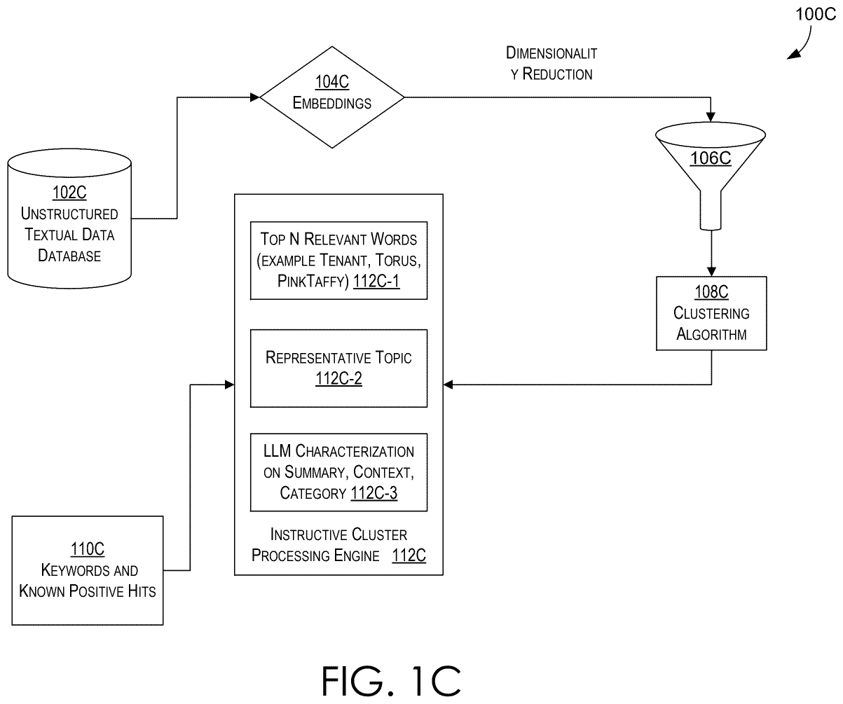

Aspects of the technical solution can be described by way of examples and with reference to FIGS. 1A-1C. FIG. 1A illustrates a cloud computing environment (system) 100, data intelligence system 100A, data analysis pipeline engine 110, data analysis pipeline resources 112, dataset 120, data embedding engine 130, dimensionality reduction engine 132, clustering engine 134, topic modeling engine 136; reasoned knowledge graph-building 140, large language model 150; and downstream processing engine 160; data intelligence client 170; and data intelligence-supported computing environment 180.

Cloud computing system 100 includes data intelligence system 100A that provides an operating environment for data analysis pipeline engine 100 that operates with data intelligence client 170 and data intelligence-supported computing environment 180. The data analysis pipeline engine 100 operates in conjunction with a data intelligence client 170, facilitating the provisioning of data analysis pipeline processing functionality that can be tailored data intelligence-supported computing environment 180. For example, through user interactions via the data intelligence client 170, the data intelligence client 170 leverages the data analysis pipeline capabilities (e.g., data analysis pipeline 112) to generate explainable analysis of large volumes of data (e.g., dataset 120) associated with data intelligence-supported computing environment 180.

Data analysis pipeline resources 112 resources include operations, interfaces, and data that support providing data analysis functionality. The operations include clustering and topic modeling that operate as unsupervised machine learning techniques to identify patterns and group similar data points or extract common themes from a dataset. Interfaces involve graphical user interfaces (GUIs) for user-friendly interaction, visualizations for pattern and trend analysis, command-line interfaces (CLIs) for automation and advanced features, APIs for integrating with other systems, and web services for remote access. The data includes raw datasets, intermediate processed data, analysis results, clustered-data outputs, and final insights for reporting and decision-making. Data analysis pipeline resources 112 enable a structured approach that ensures efficient data processing and continuous optimization, facilitating informed decision-making and effective data utilization.

By way of illustration, clustering (e.g., clustering engine 143) is performed on a filtered dataset (e.g., filtered unstructured textual data of dataset 120). The filtered dataset can be piped into a recursive data analysis graph-building (e.g., reasoned knowledge graph-building engine). For example, emails in an email corpus can be processed for recursive vulnerability graph-building. The analysis can begin on a first data instance of the filtered dataset; the data instance can include data items with known data features (e.g., emails with high-risk security keywords and/or known positive hits).

Topic modeling can be used to extract a list of top words that succinctly captures the most relevant and significant terms within a dataset. This helps in understanding the predominant themes or subjects across the dataset. Additionally, topic modeling enables the creation of extractive summaries, which distill essential information by selecting representative data items (e.g., a set of n representative emails) that encapsulate each identified cluster's content.

After clustering and topic modeling, outputs (i.e., clusters or instructive clusters) can be processed with LLMs. In particular, the clusters be processed to generate annotated clusters. For example, clusters can be processed using LLMs (e.g., LLM 140) to generate annotated clusters with categorization (e.g., category annotation) and abstractive summarization (e.g., a summary annotation). Additionally, a rational graph (e.g., reasoned knowledge graph-building engine 150) can be used for downstream analysis. Downstream analysis (e.g., downstream processing engine 160) can be associated with the specific context of data intelligence analysis (e.g., cybersecurity and legal discovery). Downstream analysis can include identifying relevant document chains; projecting and prioritizing risk; and pinpointing informative data items and information sources.

For example, in a cybersecurity context, downstream analysis can include identifying attack chains involves tracing the sequence of malicious activities, such as phishing emails, compromised accounts, malware spread, and attacker communications, to understand the full lifecycle of an attack. This is followed by projecting and prioritizing threats, where potential threats are assessed for their severity and potential impact using threat intelligence to anticipate future attacks and prioritize responses based on risk levels. Additionally, pinpointing vulnerable infrastructure and services entails identifying weaknesses in email servers, network configurations, software applications, and other critical components to focus on strengthening defenses where they are most needed.

Moreover, the data analysis pipeline 110 can support efficient management of vast volumes of textual data (e.g., emails). For example, the data analysis pipeline 110 can assist in mailbox content analysis using clustering (e.g., clustering engine 134) and topic modeling (e.g., topic modeling engine 136) to capture what kind of emails were taken to build threat actor profiles and actor intent/impact; reducing a total number of emails to tangible correlated topics; answering questions around risk content in emails; and prioritizing specific high-risk emails by targeting clusters mapped to relevant keywords and/or clusters containing known high-risk emails.

And, in a legal discovery context, downstream analysis can include identifying relevant document chains by collecting and reviewing documents and communications to understand their relationships and context, piecing together the narrative of events, and identifying key participants. Projecting and prioritizing legal risks involves assessing the strength of evidence, identifying potential liabilities, and determining the relevance of each document to the case, thereby prioritizing the most critical issues. Lastly, pinpointing key evidence and information sources means identifying the most crucial documents, emails, and communications that will influence the case's outcome, focusing on key witnesses and pivotal evidence for detailed review and analysis. For legal discovery, clustering and topic modeling can be used to analyze documents, extract pertinent information, understanding intent and impact, organizing documents into coherent themes to manage the volume of data. As such, both cybersecurity and legal discovery involve systematic analysis, risk assessment, and prioritization to achieve their respective goals in cybersecurity and legal contexts.

By way of example, the dataset 120 can include unstructured textual data, such as emails, can be organized into clusters, each described by its top words, representative emails, and an LLM-generated summary. This approach helps the data intelligence system 100A prioritize high-risk emails by targeting clusters identified with relevant top words or containing known high-risk emails. For instance, given a set of 2 million emails and a list of 107,000 known risky emails (e.g., those containing credentials), randomly sampling from this list yields only a 5% chance of encountering a risky email. However, by clustering the emails, this chance increases to 70%, as the focus is narrowed to clusters with risky hits, significantly reducing the search scope.

After detecting high-risk clusters, the data analysis pipeline 100 includes a technique associated with an agentic framework, where AI agents are employed for graph-based reasoning and inference (e.g., downstream processing engine 140, large language model 150, and rational graph-building engine 160) that enable additional data feature analysis (e.g., vulnerability risk analysis of emails) for a particular topic of interest. The reasoned knowledge graph encapsulates the idea of both inference and reasoning for graph data based on indicating a logical justification or explanation based on careful consideration and inference from available cluster-based analysis output.

With reference to FIG. 1B, FIG. 1B illustrates a flow diagram 100B associated with providing data analysis pipeline functionality. Dataset 102B (e.g., unstructured textual data) includes data items (e.g., emails) from various sources. In some embodiments, the dataset 102B may be an email corpus that is analyzed for vulnerabilities in a cybersecurity context. A data instance from the dataset 102B is filtered to generate the filtered data 104B. A data instance, when considered as a subset of a dataset, represents a specific portion of the dataset containing one or more observations or records that satisfy certain criteria or conditions.

Filtering can include de-duplicating and aggregating the dataset from different data sources. The filtered data 104B is provided to the clustering engine 106B for cluster generation. Clustering engine 106B narrows the search set of the filtered data 104B. Narrowing the filtered data 104B can be associated with criteria of a particular analysis context. A filtering criteria can include a representative data feature parameter. A representative data feature is a characteristic or attribute within a dataset that effectively summarizes or encapsulates key information about the dataset or a subset of its instances. For example, for an email data instance from a dataset, the email data instance can be narrowed via security-related criteria (e.g., emails containing high-risk security keywords and/or known positive hits, documents containing particular keywords and/or known positive hits, etc.).

In embodiments, clustering is performed on filtered emails to identify relevant groups. Each cluster is initially annotated using topic modeling to determine key terms and generate extractive summaries. Subsequently, large language models (LLMs) are employed to create abstractive summaries (i.e., summary annotations) based on risk categories or other categories of interest (i.e., category annotations). Narrowing the search set can be based on the clustering engine 106B applying edge weights to the filtered data 104B to further narrow down the data. For example, email data can be narrowed down to a community of interest (e.g., particular senders of emails). In some embodiments, the clustering engine 106B applies an algorithm capable of measuring a relative importance of pages within a hyperlinked set of the filtered data to narrow down a community of interest.

The clustering engine 106B may generate embeddings for the filtered data 106B (e.g., the filtered data associated with the community of interest). For example, the clustering engine 106B may dynamically modify data representations for each data instance for adaptation based on context. The adaptation may include one or more of changing data formatting of the filtered data for the data representations, adjusting one or more algorithm parameters, or adjusting one or more processing techniques. By way of example, the clustering engine 106B may generate the embeddings using Adaptive Data representation and Adaptation (ADA), such that the embeddings capture enough contextual information from the original sources associated with the dataset 102B. Adaptive data representation and adaptation include a dynamic process of modifying the structure or format of data and its presentation to suit changing requirements, contexts, or preferences, often in response to evolving user needs or environmental conditions.

The clustering engine 106B may apply a dimensionality reduction technique to the embeddings. In embodiments, the dimensionality of data may be reduced while preserving each embedding's intrinsic geometric and topological structure, such that the reduced dimensionality of the embedding is generated based on the associated data points being on a lower-dimensional manifold within in a higher-dimensional space. In embodiments, the embeddings are reduced using Uniform Manifold Approximation and Projection (UMAP). In embodiments, the UMAP reduction technique provides for a visualization of the filtered data in a two-dimensional space.

The clustering engine 106B may generate the clusters using the lower dimensional embeddings generated by UMAP. In embodiments, the clustering engine 106B may generate the clusters by incorporating one or more hierarchical clustering techniques to generate a flexible and robust clustering of the lower dimensional embeddings, such that the hierarchy of clusters are based on density for the subsequent extraction of clusters at multiple levels of granularity that distinguish noise. The clusters may be generated based on the number of points within a particular radius associated with each cluster, the radius being associated with a measurement of the density around each cluster point. In some embodiments, the clusters are generated using Hierarchical Density-Based Spatial Clustering of Applications with Noise (HDBSCAN).

The clustering engine 106B may adapt the number of clusters for different scenarios and applications (e.g., by manual tuning, automated tuning, adjusting the minimum cluster size, etc.). In embodiments, the clusters may be adjusted to be more general or more specific. In addition, hyper-parameters such as the initial number of emails and the size of the embedding may be adjusted via the clustering engine 106B.

Downstream prompting 110B includes categorization 110B-1 and summarization 110B-2. Downstream prompting 110B can be performed via machine learning models may access clusters generated by the clustering engine 106B to perform content categorization and subject categorization. In embodiments, the downstream prompting applies one or more machine learning techniques to automatically categorize the clusters based on semantic similarities (e.g., associated with each of email content and email subjects of the original sources associated with the dataset 102B), for subsequent identification and prioritization of particularly targeted data (e.g., high-risk sensitive data, data associated with a particular targeted topic, etc.).

In embodiments, the downstream prompting 110B may apply the one or more of a categorization 110B-1 (e.g., content categorization) and summarization 110B-2 (e.g., subject summarization) using one or more predefined sets rules to categorize content and subject matter associated with the clusters using one or more of keywords, phrases, other patterns, etc. In embodiments, the downstream prompting 110B may analyze one or more embeddings associated with a cluster to identify semantic meanings based on one or more clustering algorithms that group the embeddings of the clusters into topics and generating a topic representation refinement for each cluster that is interpretable.

For example, downstream prompting 110B may apply BERTopic, a topic modeling technique leveraging BERT (Bidirectional Encoder Representations from Transformers) embeddings to improve the quality and coherence each topic generated from associated textual data for the clusters. To illustrate, BERTopic may be used to identify a topic of each cluster, and then one or more LLMs are used to describe each cluster. In embodiments, BERTopic may be used to extract topics by computing a class-based TF-IDF matrix, which may be enhanced by the inclusion of domain-specific keywords. For a better cluster characterization, these terms are weighted more heavily in the topic representation. The integration of the keywords can provide a tailored analysis (e.g., relevant to particular data security concerns).

In this way, the volume of the dataset 102B can be reduced to tangible correlated topics, and the summaries for each of these topics can provide answers and relevant information for the question of what was potentially taken from the dataset 102B. For example, a representative set of documents or emails can represent a cluster, and the LLM summary of the cluster can be used for identifying clusters of interest. In embodiments, the clusters and communities detected (e.g., based on email communication traffic) may also be used as filtering pivots on input data for categorization prompts of the downstream prompting 110B. such that the final outputs from the downstream prompting 110B and the downstream analysis 114B are merged (i.e., merged data analysis pipeline output) and piped into the assessment framework 116B, as discussed below.

The reasoned knowledge graph-building engine 112B may receive the clusters generated by the clustering engine 106B. In this way, the combination of clustering, the application of the content categorization (i.e., categorization 110B-1) and subject summarization (i.e., summarization 110B-2), and AI agents of the reasoned knowledge graph-building engine 112B can essentially bucket topics of interest or grouped topics of interest for data having particularly relevant semantics and significance associated with a target or goal. For example, the reasoned knowledge graph-building engine 112B may generate vulnerability graphs or other types of graphs from the buckets of interest that point to related topics of interest, such that the generated graph(s) can focus on the clusters that relate to those topics for correlating specific topics for the downstream analysis 114B (e.g., the attack chain analyzer 114B-1, the project and prioritization of targets 114B-2, the identification of vulnerable infrastructure and services 114B-3, the assessment framework 116B).

In embodiments, the final outputs associated with the downstream prompting 110B and downstream analysis 114B may be merged into a merged data analysis pipeline output associated with a comprehensive assessment framework. An assessment framework provides a structured approach or set of guidelines used to evaluate or measure performance, progress, or effectiveness in a particular domain or context, providing a systematic way to assess various aspects of a system, process, or entity. For example, a high-risk data or email risk assessment framework could involve evaluating factors such as email content, sender reputation, attachment types, and recipient behavior against predefined risk criteria to determine the likelihood and severity of potential threats. This assessment framework supports generating data analysis pipeline output associated with automated analysis tools, machine learning algorithms, and human oversight on data analysis (e.g., classifying emails into risk categories and prioritize responses based on the identified risks). In this way, the merged data analysis pipeline output refers output from incorporating the annotation clusters—indicating group characteristics or insights—and a reasoned knowledge graph—depicting logical connections or justifications for findings—into an structured evaluation system (i.e., an assessment framework).

The assessment framework may be associated with an assessment framework interface. For example, for a risk assessment framework for emails features, a user-friendly dashboard that displays metrics on email data items. Users can input email parameters and review automated risk scores generated by the data analysis pipeline algorithms. The assessment framework interface provides detailed reports on detected vulnerabilities, categorized by severity, and offers actionable recommendations for mitigation. It includes interactive charts and graphs to visualize trends and potential risk factors. An alert system notifies users of critical threats, ensuring prompt response and continuous monitoring of email security

In embodiments, the reasoned knowledge graph-building engine 112B uses the clusters generated by the clustering engine 106B to iteratively build out a graph using reversible jump Markov chain of AI/LLM agents that are able to iteratively build out this graph. For example, the reversible jump corresponding to the reasoned knowledge graph-building engine 112B corresponds to initiation of graph building using AI/LLM agents for recursive tasks iteratively, such that small moves associated with building the graph are iteratively implemented using reversible jump machinery. The AI/LLM agents are built in such a way that they recursively iterative until converging at an optimal solution, building upon previous insights associated with the clusters so that graph generation (or document generation) can implement very large data structures. By way of illustration, the recursive nature may comprise incrementally adding, removing, deleting, splitting, merging, etc., components in a probabilistic manner.

In one example implementation, reasoned knowledge graph-building engine 112B and implementation of the downstream analysis 114B may detect the context of a particular vulnerability, as well as other vulnerabilities that may be related to the particular vulnerability and an associated threat actor profile. In this way, the reasoned knowledge graph-building engine 112B and implementation of the downstream analysis 114B may identify particular capabilities of the threat actor associated with the threat actor profile, a particular stage of the attack, as well as additional threat actor profile features that were previously undetectable. In embodiments, the reasoned knowledge graph-building engine 112B and implementation of the downstream analysis 114B are a probabilistic inference machine that keeps iterating and continues going through the associated steps. As such, the reasoned knowledge graph-building engine 112B and implementation of the downstream analysis 114B have the ability to scale out the LLM(s) to build these large data structures (graphs, document summarization, or entity summarization).

With reference to FIG. 1C, FIG. 1C illustrates a flow diagram 100C associated with providing data analysis pipeline functionality. A first data instance including a set of data items from the unstructured textual data database 102C may be provided to embeddings 104C for embedding generation. The embedding generation may include applying one or more advanced text embedding models (e.g., Bidirectional Encoder Representations from Transformers (BERT), Generative Pre-trained Transformer 3, Robustly optimized BERT approach, etc.). An embedding model is employed to generate the embeddings, such that the embeddings capture enough contextual information from the original sources associated with the unstructured textual data database 102C.

The embeddings may be subjected to dimensionality reduction 106C (e.g., via UMAP), such that the dimensionality reduction preserves the intrinsic structure of the data. The reduced-dimensional embeddings are provided to the clustering algorithm 108C (e.g., HDBSCAN), which generates clusters (e.g., a plurality of instructive clusters) accurately reflecting patterns within the data. An instructive cluster can refer to a grouping of data items based on data points that provides valuable insights or information about specific patterns or trends within a dataset. An instructive cluster can be particularly useful in highlighting key features, relationships, or anomalies, aiding in better decision-making and understanding of the data. By way of illustration, the clustering algorithm 108C analyzes the patterns and nuances of communication within an organization associated with the unstructured textual data database 302 to pinpoint specific user communities that may not be readily apparent through standard hierarchical structures.

The clusters from the clustering algorithm 108C and the keywords and known positive hits 110C associated with the particular targeted data of interest are provided to the instructive cluster processing engine 112C. The instructive cluster processing engine 112C may include top N relevant words 112C-1, representative topic(s) 112C-2, and LLM characterization on a summary of the clusters, context of the clusters, and a category for the clusters 112C-3. In an example, the instructive cluster processing engine 112C may implement content analysis on a plurality of mailbox data, such that the clustering and category modelling capture what kind of emails were taken (e.g., to build threat actor profiles and actor intent/impact analyses).

In embodiments, the LLM characterization on a summary of the clusters, context of the clusters, and a category for the clusters 112C-3 may answer questions around “what was taken” from emails. In some embodiments, the characterization on a summary of the clusters, context of the clusters, and a category for the clusters 112C-3 may answer how important a vulnerability is, thereby detecting the context of a vulnerability and all the other related vulnerabilities and the threat actor profile. In embodiments, the instructive cluster processing engine 112C may prioritize specific high-risk emails by targeting clusters mapped to relevant keywords or clusters containing known high-risk emails.

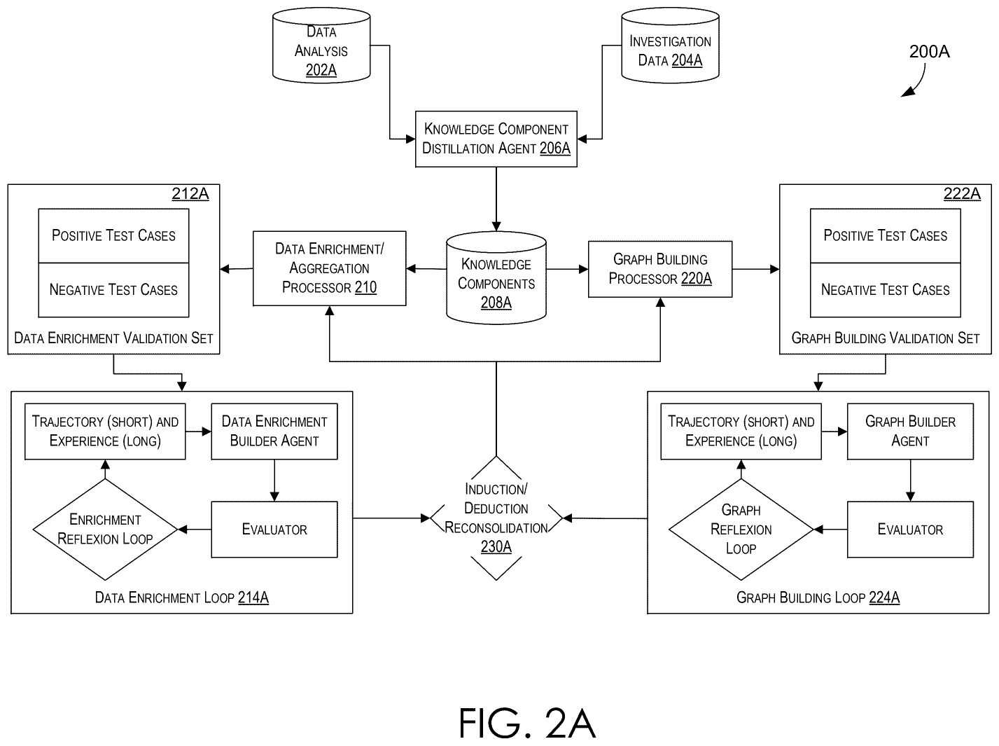

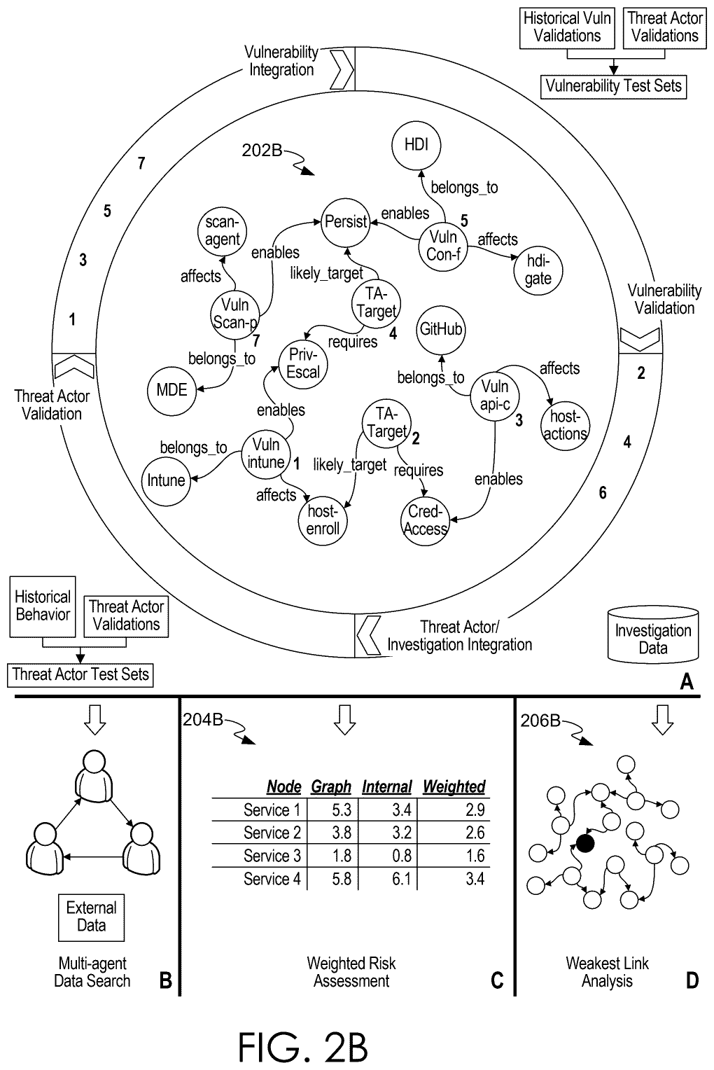

With reference to FIG. 2A, FIG. 2 illustrates a flow diagram 200A associated with a cybersecurity example implementation of the technical solution described herein. A data analysis 202A (e.g., vulnerability analysis) and investigation data 204A are provided to the knowledge component distillation agent 206A. The knowledge component distillation agent 206 supports transfer of knowledge from a complex model to a simpler one by training the simpler model to mimic the behavior of the complex model. The output can be knowledge components 208A, for example, specific elements or aspects of information that have been distilled or transferred to another through techniques like knowledge distillation. These knowledge components can include learned patterns, representations, decision-making processes, or any other form of knowledge encoded within the original model. The outputs from the knowledge component distillation agent 206 are provided to a graph building processor 220A and a data enrichment/aggregation processor 210A for iteratively building a reasoned knowledge graph (e.g., a hypergraph). For example, after detecting high-risk clusters, AI agents for graph-based reasoning and inference to enhance vulnerability risk analysis may be introduced.

The data analysis pipeline operates based on an agentic framework associated with AI agents (e.g., Reflexion agents and Reversible Jump Markov Chain-LLM, multi-modal, specialized agents). Reflexion agents and Reversible Jump Markov Chain-LLM agents are employed because of their demonstrated effectives on large and diverse datasets and scaling. Reflexion agents excel in iterative improvement and learning, while Reversible Jump Markov Chain-LLM agents are adept at constructing complex data structures (e.g., graphs). When these agents work in concert (e.g., data enrichment loop 214A and graph building loop 224A, they form a powerful information processing system that is capable of not only assembling the initial hypergraph, but also continuously updating it with new findings. This iterative process ensures that the reasoned knowledge graph-a hypergraph-remains an accurate and up-to-date representation of the organization's security posture, allowing, for example, a cybersecurity system to respond swiftly to emerging threats and vulnerabilities.

By way illustration, Reflexion and RJ-MC-LLM agents can be leveraged for automated data enrichment for vulnerabilities and graph building. The data analysis pipeline provides an operational framework where knowledge from the investigation are distilled into a list of knowledge components (e.g., knowledge components 208A) that are used for the downstream agents. Each test set can used to validate and iterate on a given task, such as graph building, or graph enrichment from external data.

The data analysis pipeline will then iterate between two sets of Reflexion RJ-MC-LLM agent loops, first data enrichment loop 214A (e.g., KQL queries, Filters, Aggregations) will iteratively work on enriching the vulnerability graph with new information. These enriched data may come from other data sources, such as rules or heuristics and may be KQL queries, or similar ingestion; and a Reflexion reconsolidator will process any output from the processing rules that may require the graph building Agent Loop to address. The graph building loop 224A the subsequently operates to add new information to the graph, either through building correlation rules, or directly modifying the graph; and Reflexion reconsolidator will relay any information needed for the data processing validator back into its validation set such that any missing data processing (e.g., alerts, detections, anomalies) are properly added to the data processing configuration.

As such, the AI agents include induction-deduction reconsolidation 230A, Reflexion agents, RJ-MC-LLM agents to build vulnerability graphs for risk assessment and downstream triage and analysis. For example, the data enrichment/aggregation processor 210A may provide output associated with a data enrichment validation set 212A including positive test cases and negative test cases. Data enrichment loop 214A may comprise iterative loops and refinements that are performed based on vulnerability and other risk signals to reason over and induct a scoped targeted graph for downstream analysis. For example, the graph building processor 220A can generate a graph building validation set 222A including positive test cases and negative test cases, which may be provided to graph building loop 224A comprising iterative loops and refinements that are performed based on vulnerability and other risk signals to reason over and induct a scoped targeted graph for downstream analysis.

The reasoned knowledge graph may be used for further downstream analysis, such as multi-agent data searching to generate risk analyses and to perform threat analysis. In embodiments, a page ranking algorithm or another similar analysis can be performed to rank vulnerabilities based on graph relationships, and the ranked vulnerabilities may be weighted (e.g., with internal risks or another targeted feature) to generate a new weighted risk. In embodiments, a graph-cut community detection algorithm may be applied to analyze and determine the particular targets (e.g., a weak vulnerability within an organization), such that key nodes in the graph are identified (e.g., for triaging).

With reference to 2B, FIG. 2B is a schematic illustrating iterative data processing optimization. A dataset 220A can include a plurality of data items that can have different measures of relevance for a particular topic. For example, emails have different risk scores. The dataset 220A can be processed using an iterative data processing optimization loop from 220A to 224D for downstream analysis using prompt LLMs 224E.

By way of illustration, the induction-deduction technique and RJ-MC-LLM agents may be used to build vulnerability graphs or other types of graphs, such as graphs 202B, 204B, and 206B (e.g., for risk assessment, downstream triage and analysis, etc.). For example, iterative loops and refinements may be performed according to vulnerability and other risk signals to reason over and induct a scoped targeted graph for downstream analysis (e.g., graph 202B). As another example, the induction and deduction agent loops (e.g., graph building loop 224A and data enrichment loop 214A may be designed and applied for continuous learning and validation for the iterative refinement of the vulnerability hypergraph 202B. A hypergraph includes hyperedges that can connect vertices. In a hypergraph, each hyperedge can be a subset of the vertex set, allowing for the modeling of more complex relationships between multiple entities simultaneously.

An implementation of Reflexion and RJ-MC-LLM agents in a cybersecurity context can be based on accessing investigation data and vulnerability data (e.g., vulnerabilities extracted from the email) to iteratively build out complex vulnerability graphs that jointly represent the information and weaknesses present in our systems, along with the known targets and behavior of the threat actor. A step 1, the RJ-MC-LLM agent proposes to add a hyperedge that captures some of the vulnerability knowledge from the emails; at step 2, the LLM proposes adding a new node that a host that is affected by the vulnerability is a likely target, but requires an additional feature to work (e.g., a credential); at step 3, the model proposes adding in a new hyperedge that links a vulnerability in the email work stream to the threat actor hyperedges, now creating an attack path between multiple vulnerabilities.

In embodiments, the downstream graphs 202B, 204B, and 206B can be used for further analysis, such as multi-agent data search to understand risks and perform threat analysis. For example, a page ranking algorithm or another similar analysis can be performed to rank vulnerabilities based on graph relationships and weigh the vulnerabilities with predefined risks to generate additional weighted risks. In embodiments, a graph-cut community detection algorithm may be applied to determine one or more weak vulnerabilities (e.g., in an organization), and isolate key nodes in the graph 202B, 204B, or 206B. In embodiments, the key nodes isolated may be used to generate, adapt, and modify the threat actor's capabilities within the threat actor profile, as well as determine a particular stage of an attack. By way of example, the key nodes isolated may be used to detect an API vulnerability which was previously undetected as risky. As another example, the nodes in the graph 202B, 204B, or 206B may be used to determine the importance of a node, a critical weak spot associated with the nodes, etc. In some embodiments, the key nodes isolated may be used to block or counter a particular threat actor.

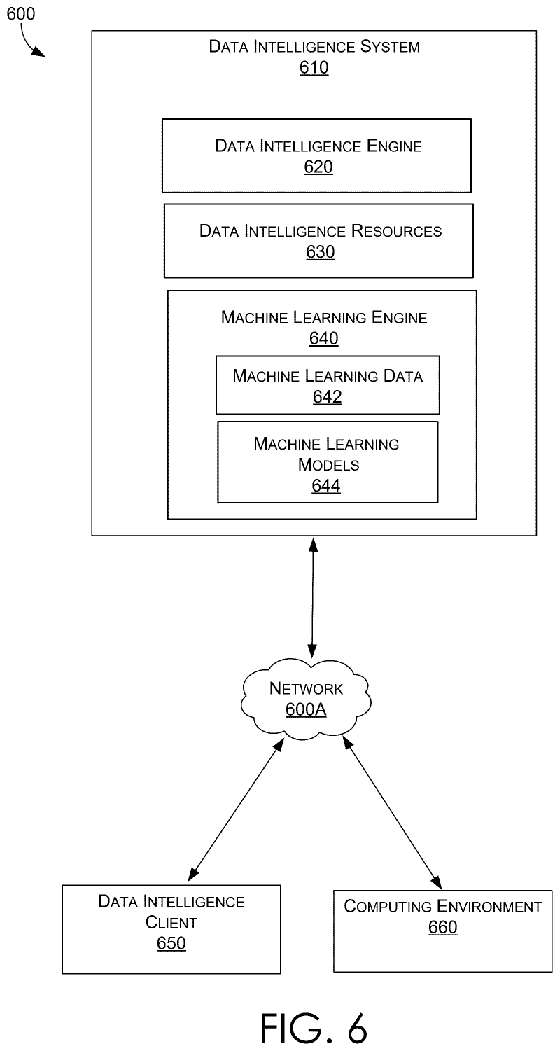

Aspects of the technical solution have been described by way of examples and with reference to FIGS. 1A, 1B, 1C, 2A and 2B. FIG. 1A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

### EXAMPLE METHODS

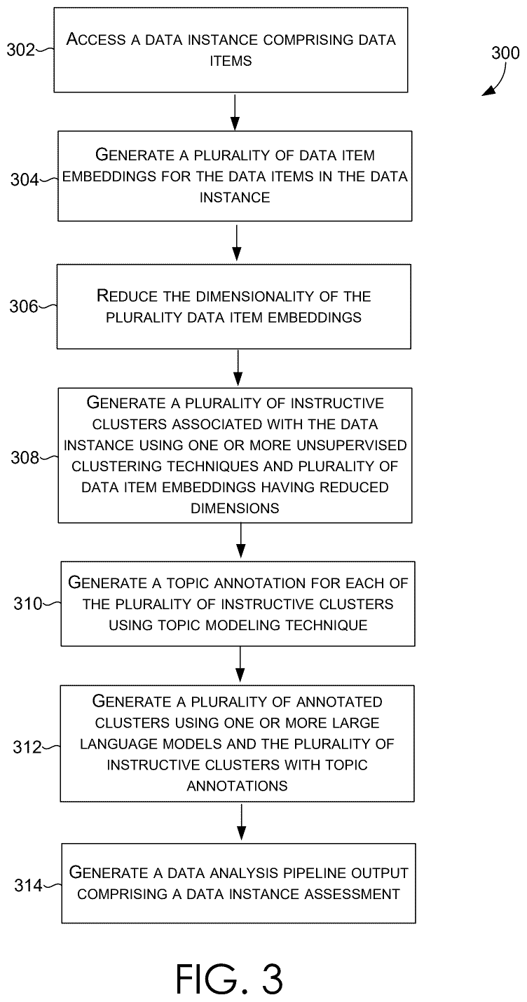

With reference to FIGS. 3, 4, and 5, flow diagrams are provided illustrating methods for providing iterative data processing optimization using a data analysis pipeline engine in a data intelligence system. The methods may be performed using the design system described herein. In embodiments, one or more computer-storage media having computer-executable or computer-useable instructions embodied thereon that, when executed, by one or more processors can cause the one or more processors to perform the methods (e.g., computer-implemented method) in the data intelligence system (e.g., a computerized system).

Turning to FIG. 3, a flow diagram is provided that illustrates a method 300 for providing iterative data processing optimization using a data analysis pipeline engine in a data intelligence system. At block 302, access a data instance comprising data items. The data instance is associated with a dataset. At block 304, generate a plurality of data item embeddings for the data items in the data instance. At block 306, reduce the dimensionality of the plurality of data item embeddings. At block 308, using one or more unsupervised clustering techniques and the plurality data item embeddings having reduced dimensions, generating a plurality of instructive clusters associated with the data instance. At block 310, using a topic modeling technique, generate a topic annotation for each of the plurality of instructive clusters. At block 312, using one or more large language models and the plurality of instructive, generate a plurality of annotated clusters, wherein an annotated cluster comprises a category annotation and a summary annotation. At block 314, generate a data analysis pipeline output comprising a data instance assessment.

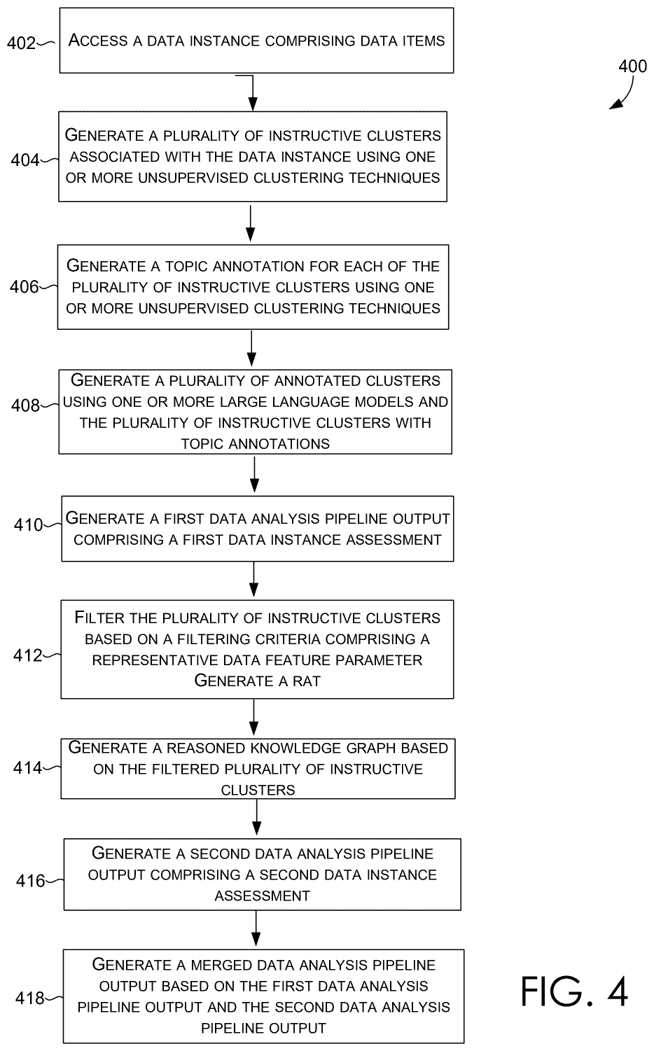

Turning to FIG. 4, a flow diagram is provided that illustrates a method 400 for providing iterative data processing optimization using a data analysis pipeline engine in a data intelligence system. At block 402, access a data instance comprising data items. The data instance is associated with a dataset. At block 404, using one or more unsupervised clustering techniques, generate a plurality of instructive clusters associated with the data instance. At block 406, using a topic modeling technique, generate a topic annotation each of the plurality of instructive clusters. At block 408, using one or more large language models and the plurality of instructive clusters with topic annotations, generate a plurality of annotated clusters. An annotated cluster comprises a category annotation and a summary annotation. At block 410, generate a first data analysis pipeline output comprising a first data instance assessment. At block 412, filter the plurality of instructive clusters based on a filtering criteria comprising a representative data feature parameter. At block 414, generate a reasoned knowledge graph based on the filtered plurality of instructive clusters. At block 416, generate a second data analysis pipeline output comprising a second data instance assessment. At block 418, generate a merged data analysis pipeline output based on the first data analysis pipeline output and the second data analysis pipeline output.

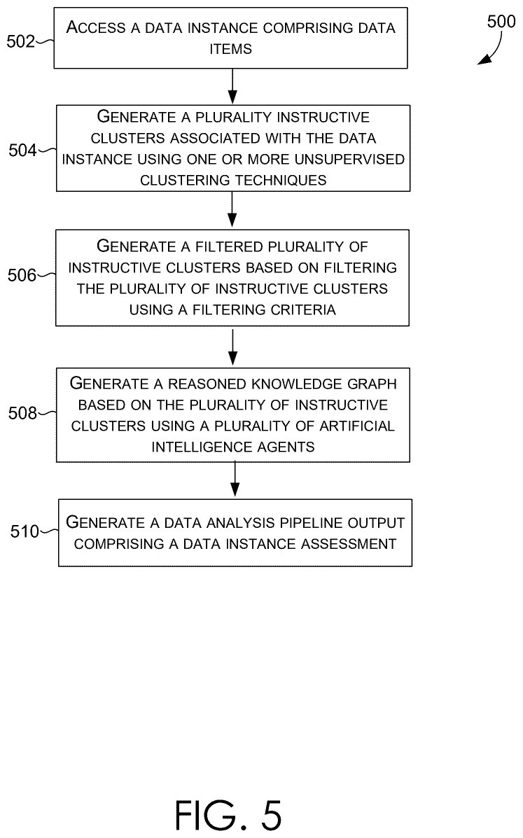

Turning to FIG. 5, a flow diagram is provided that illustrates a method 500 for providing iterative data processing optimization using a data analysis pipeline engine in a data intelligence system. At block 502, access a data instance comprising data items. The data instance is associated with a dataset. At block 504, using one or more unsupervised clustering techniques, generate a plurality of instructive clusters associated with the data instance. At block 506, generate a filtered plurality of instructive clusters based on filtering the plurality of instructive clusters using a filtering criteria comprising a representative data feature. At block 508, using a plurality of artificial intelligence agents, generate a reasoned knowledge graph based on plurality of instructive clusters. At block 510, generate a data analysis pipeline out comprising a data instance assessment.

### TECHNICAL IMPROVEMENT

Embodiments of the present techniques have been described with reference to several inventive features (e.g., operations, systems, engines, and components) associated with a design system. Inventive features described include: operations, interfaces, data structures, and arrangements of computing resources associated with providing the functionality described herein relative with reference to a data analysis pipeline engine. Functionality of the embodiments of the present invention have further been described, by way of an implementation and anecdotal examples—to demonstrate that the operations for providing the data analysis pipeline engine as a solution to a specific problem in data intelligence technology to improve computing operations in data intelligence systems.

Advantageously, the data analysis pipeline can provide supports a proactive approach to managing different types of domains of large data sets. For example, the data analysis pipeline can review email data with a nuanced and adaptive approach to uncover threats that may be missed by conventional methods, thereby significantly reducing the risk of security breaches. In addition, response times to potential threats can be reduced with increased visibility provided to threat management. In this way, the data analysis pipeline can provide risk management, enabling a real-time comprehensive assessment of vulnerabilities, their potential impact, and the relationships between them. It assists in identifying and prioritizing the most critical risks, ensuring that resources are allocated effectively for mitigation and response. Clustering, topic modeling, and LLMs offer a technically superior approach to email analysis for security purpose to deliver a comprehensive and automated data intelligence system for cybersecurity needs in terms of breached email content analysis.

Moreover, by employing clustering techniques on a massive initial email database, potentially containing millions of emails, the volume of data can be reduced to a more manageable and strategically focused subset. This process isolates clusters that are potentially high-risk. For example, analysts can detect these clusters by applying two primary methods of detection: searching for clusters that contain any previously identified (known) risky emails and/or scanning the topics within each cluster for specific keywords. If a cluster includes a known risky email, or its topic contains one or more of the targeted keywords, it is flagged as relevant and retained for further analysis. This targeted approach ensures that only the most suspect data is prioritized, making the vulnerability assessment process both efficient and effective.

With regard to vulnerability risk assessment, the data analysis pipeline include integration of AI-driven graph construction with traditional machine learning optimization techniques for comprehensive vulnerability risk assessment. The induction and deduction agent loops are engineered for continuous learning and validation, enabling iterative refinement of the vulnerability hypergraph. These are supported by the different types of agents (e.g., Reflexion agents and Reversible Jump Markov Chain-LLM agents) which specialize in creating and manipulating complex data structures like hypergraphs through reversible jump techniques. In particular,

The graph-based reasoning induction approach provides a strategic advantage in security risk management by enabling teams to predict and counteract complex attack vectors. It facilitates a deeper understanding of how different vulnerabilities can be exploited in concert to breach services, thus allowing for more effective preemptive measures. Moreover, it provides the means to comprehend and proactively tackle complex attack scenarios. It empowers security teams to anticipate how an attacker might exploit vulnerabilities across different services to compromise an organization. For instance, the system could reveal how a Multi-Factor Authentication (MFA) bypass vulnerability in identity services could be combined with an authorization vulnerability in a cloud-based endpoint management tool for privilege escalation.

Additionally, a significant technical advantage of the data analysis pipeline is ontology-free data processing capability, allowing the data analysis pipeline to integrate structured, semi-structured, and unstructured data without a predefined ontology. This is made possible by a series of prompts that intelligently format and incorporate data into the hypergraph throughout the relevant analysis process. The data analysis pipeline also excels at maintaining complex, large data structures essential for accurately representing the network of a selected data feature (e.g., vulnerabilities). The RJ-MC-LLM agents leverage reversible jump mechanics to manage hypergraphs that may include hundreds of thousands of nodes and edges. During security incidents, these agents have proven their scalability in the iterative construction and refinement of hypergraphs.

Furthermore, the data analysis pipeline adeptly captures uncertain information with varying degrees of certainty. Much of this capability is attributed to the RJ-MC-LLM component, which processes and updates knowledge as new data is integrated. This adaptability was particularly beneficial during security incidents where the agents needed to adjust to evolving threat intelligence.

### Additional Support for Detailed Description

### Example Data Intelligence System in a Cloud Computing Environment

Referring now to FIG. 6, FIG. 6 illustrates a computing environment in which implementations of the present disclosure may be employed. In particular, FIG. 6 shows a high level architecture of an example cloud computing platform 600 and data intelligence system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services-including compute, servers, storage, databases, networking, and intelligence. The components of cloud computing environment 600 may communicate with each other over a network 600A which may include, without limitation, one or more local area networks (LANs) and/or wide area networks (WANs).

The data intelligence system 610 provides data intelligence functionality for computing environments. The data intelligence system 610 is a platform or framework that leverages advanced technologies such as artificial intelligence (AI), machine learning (ML), data mining, and big data analytics to extract actionable insights and knowledge from large and complex datasets. In this way, the data intelligence system 610 provides a computing environment that enables organizations to make informed decisions and optimize operations.

The data intelligence system 610 can be implemented as a security management system that supports planning, implementing, controlling, and monitoring security measures to protect assets, resources, and information from various threats and risks in computing environment. Data intelligence system 610 as a security management system is configured to trigger alerts for potential or actual threats—including suspicious behavior or malicious behavior—in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert. The security management system can be a security management system described in U.S. patent application Ser. No. 18/451,405, filed Aug. 17, 2023, entitled “ARTIFICIAL INTELLIGENCE ENGINE IN A SECURITY MANAGEMENT SYSTEM,” which is incorporated herein by reference in its entirety.

The data intelligence system 610 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The data intelligence system 610 includes a data intelligence engine 620 that is a computing environment that supports executing computational tasks associated with the data intelligence system 610. The data intelligence engine 620 can be a hardware or software component that performs computational operations, such as, mathematical calculations, data processing, and algorithm execution. The data intelligence system 610 integrates data intelligence resources 630 into data intelligence system 610 to effectively provide data intelligence functionality in a computing environment.

The data intelligence engine 620 may collect, aggregate, and integrate data from diverse sources, including structured and unstructured data, internal and external data sources, streaming data, and historical data repositories. The data intelligence engine 620 may further applying a variety of analytical techniques and algorithms, they automate the process of extracting insights, employing machine learning algorithms, AI techniques, and predictive analytics to discover patterns, classify data, make predictions, and generate recommendations.

The data intelligence engine 620 provides visualization tools and dashboards to enable users to explore data, identify trends, and communicate insights effectively, while robust data governance policies and security measures ensure that data is managed and accessed securely, compliantly, and ethically. The data intelligence system 610 is designed for scalability and performance, in this way the data intelligence system 610 can handle large volumes of data and support high-performance analytics, including real-time and streaming analytics capabilities for faster decision-making and proactive interventions.

The data intelligence resources 630 refer to computing elements (e.g., components, capability, or entities) that collectively enable the data intelligence engine 620 operations. The data intelligence resources 630 encompass a spectrum of computing elements, beginning with the diverse operations the data intelligence resources 630 can perform, ranging from complex computations to data manipulations. Interfaces, an integral part of the data intelligence resources 630, provide the means for both user interaction and seamless integration with external systems, ensuring a dynamic and interactive computing experience. The data facet of the data intelligence resources 630 involves various types: input data, which is the information provided for processing; processing data, representing the data manipulated during computational tasks; and output data, the results generated by the data intelligence engine 620. In this way, the data intelligence resources 630 support the broader data intelligence engine 620 and data intelligence system 610.

Data intelligence resources 630 include operations, interfaces, and data that support providing data intelligence functionality-operations encompass the tasks performed on the data, interfaces facilitate interaction with the data intelligence system 610, and data serves as the input and output of the system's operations, forming the core components of a data intelligence system. In particular, iterations in a data intelligence system 610 encompass tasks such as data acquisition, preprocessing, analysis, model training, inference, visualization, and reporting. Operations involve manipulating data to extract insights and intelligence. For instance, preprocessing may involve cleaning and transforming data, while analysis could include descriptive statistics or predictive modeling. Interfaces serve as points of interaction between users, applications, and the system, facilitating access to functionality and consumption of outputs. Examples include graphical user interfaces (GUIs), command-line interfaces (CLIs), and application programming interfaces (APIs), and data visualization tools, which allow users to interact with and visualize results. Data, comprising raw and processed information, serves as the input and output of system operations. Data may originate from various sources, structured or unstructured, and undergo preprocessing before analysis. Examples include customer data, financial data, and sensor data stored in formats like databases or data lakes.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The data intelligence client 650 supports access to data intelligence system 610 660. The data intelligence client 650 can be provided as a user client or an administrator client to support user and administrator functionality associated with the computing environment 660, data intelligence engine 620, or data intelligence system 610. The data intelligence client 650 can also support accessing data intelligence visualizations and causing display of the data intelligence visualization. The data intelligence client 650 can include a data intelligence engine client that supports receiving data intelligence information associated data intelligence engine 620 output from the data intelligence system 610 and causing presentation of the data intelligence information. The data intelligence information can specifically include data intelligence visualizations associated with the data intelligence engine 620 output.

Data intelligence client 650 provides a graphical or command-line interface for users or administrators to interact with data intelligence system 610. The data intelligence client 650 serves as the interface between users or systems and the underlying data intelligence system, facilitating interactions, querying data, retrieving results, and visualizing insights derived from analyzed data. Users can configure and customize system behavior, adjust parameters, and define workflows through the client interface, tailoring the system to specific use cases or requirements. Interactive visualization tools, including charts, graphs, maps, and dashboards, enable users to explore and interpret data intuitively. Some clients offer built-in tools for data analysis, statistical modeling, and machine learning, allowing users to uncover patterns and trends within the data. Collaboration features support sharing insights, collaborating on analyses, and communicating findings with colleagues or stakeholders. Security measures such as user authentication, access control, encryption, and audit logging ensure data protection and compliance with security policies and regulations.

The data intelligence client 650 can further support executing a remediation action. In particular, the security posture visualization can include a remediation action for an alert associated with data intelligence engine 620 output. The data intelligence client 650 can receive an indication to perform the remediation action associated with data intelligence engine 620 output. Based on receiving the indication to execute the remediation action, the data intelligence client 650 can communicate the indication to execute the remediation action to cause execution of the remediation action.

Computing environment 660 is a computing environment that is integrated into the data intelligence system 610. The computing environment 660 is characterized by an infrastructure, where data from various sources within the ecosystem, including servers, networks, applications, sensors, and user interactions, can be aggregated and processed by the data intelligence system 610 to derive actionable insights. The computing environment 660 can be associated with middleware and integration layers facilitate seamless data flow, while computing infrastructure, encompassing cloud-based resources, distributed computing frameworks, and optimized storage systems, supports functionality associated with the data intelligence.

### Example Distributed Computing System Environment

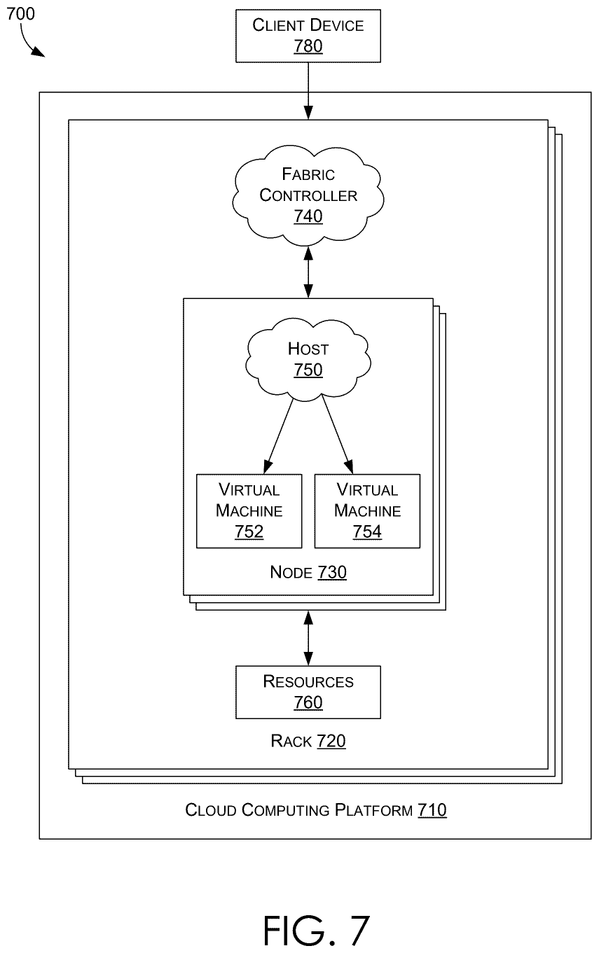

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

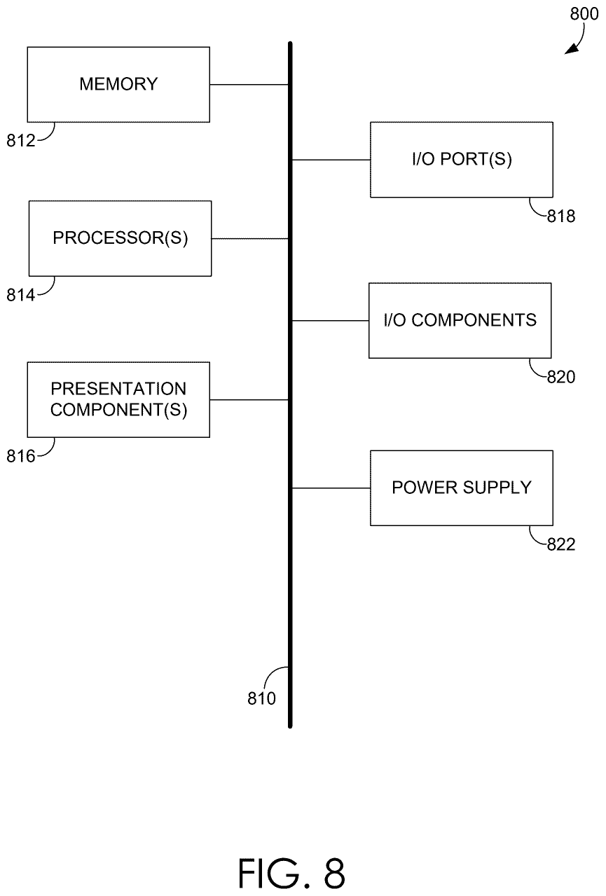

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a data instance comprising data items, wherein the data instance is associated with a dataset;
generating a plurality of data item embeddings for the data items in the data instance;
reducing dimensionality of the plurality of data item embeddings;
using one or more unsupervised clustering techniques and plurality of data item embeddings having reduced dimensions, generating a plurality of instructive clusters associated with the data instance;
using a topic modeling technique, generating a topic annotation for the plurality of instructive clusters;
using one or more large language models (LLMs) and the plurality of instructive clusters with topic annotations, generating a plurality of annotated clusters, wherein an annotated cluster comprises a category annotation and a summary annotation; and
using the plurality of annotated clusters, generating a data analysis pipeline output comprising a data instance assessment.

2. The system of claim 1, wherein the one or more unsupervised clustering techniques include Hierarchical Density-Based Spatial Clustering of Applications with Noise (HDBSCAN) clustering and Spherical k-means clustering, the one or more unsupervised clustering techniques are executed on reduced data item embeddings associated with dimensionality reduction using Uniform Manifold Approximation and Projection.

3. The system of claim 1, wherein the topic modeling technique is based on class-based TF-IDF (Term Frequency-Inverse Document Frequency) matrix and seed words that are representative of a data features to be extracted from the plurality of instructive clusters, wherein a topic annotation is a top word assigned to an instructive cluster, the top word summarizing subject matter encapsulated within its contents.

4. The system of claim 1, wherein an LLM from the plurality of LLMs supports scanning content data items in an instructive cluster, wherein the data items are scored and prioritized based on predefined categories associated with scanned content of the data items.

5. The system of claim 1, the operations further comprising:
generating a filtered plurality of instructive clusters based on filtering the plurality of instructive clusters using a filtering criteria comprising a representative data feature parameter;
using a plurality of artificial intelligence (AI) agents and the filtered plurality of instructive clusters, generating a reasoned knowledge graph, wherein the plurality of AI agents include one or more of the following: Reflexion agents and Reversible Jump Markov Chain-LLM agents; and
using the reasoned knowledge graph, generating a second data analysis pipeline output comprising a second data instance assessment.

6. The system of claim 5, the operations further comprising, using the first data analysis pipeline output and the second data analysis pipeline output, generating a merged data analysis pipeline output.

7. The system of claim 1, wherein the data analysis pipeline output is associated with a data analysis pipeline, wherein the data analysis pipeline is an unsupervised learning pipeline based on clustering, topic modeling, and large language models that enable generation of reasoned knowledge graphs based on a plurality of graph-based reasoning and inference agents that execute induction and deduction loops.

8. A method, the method comprising:
accessing a data instance comprising data items, wherein the data instance is associated with a dataset;
using one or more unsupervised clustering techniques, generating a plurality of instructive clusters associated with the data instance;
generating a filtered plurality of instructive clusters based on filtering the plurality of instructive clusters using a filtering criteria comprising a representative data feature parameter;
using a plurality of artificial intelligence (AI) agents and the filtered plurality of instructive clusters, generating a reasoned knowledge graph; and
using the reasoned knowledge graph associated with the plurality of instructive clusters, generating a data analysis pipeline output comprising a data instance assessment.

9. The method of claim 8, wherein the one or more unsupervised clustering techniques include Hierarchical Density-Based Spatial Clustering of Applications with Noise (HDBSCAN) clustering and Spherical k-means clustering, the one or more unsupervised clustering techniques are executed on reduced data item embeddings associated with dimensionality reduction using Uniform Manifold Approximation and Projection.

10. The method of claim 8, wherein the plurality of AI agents are based on Reflexion agents and Reversible Jump Markov Chain-LLM.

11. The method of claim 8, wherein generating the reasoned knowledge graph is based on an induction-deduction technique associated with executing iterative loops and refinements for continuous learning and validation.

12. The method of claim 8, the method further comprising:
using a topic modeling technique, generating a topic annotation the plurality of instructive clusters;
using one or more Large Language Models (LLMs) and the plurality of instructive clusters with topic annotations, generating a plurality of annotated clusters, wherein an annotated cluster comprises a category annotation and a summary annotation; and
generating a second data analysis pipeline output comprising a second data instance assessment.

13. The method of claim 8, the method further comprising applying a graph-cut community detection algorithm to partition the reasoned knowledge graph into clusters by iteratively splitting or merging nodes to identify densely connected communities in the reasoned knowledge graph.

14. The method of claim 8, wherein the data analysis pipeline output is associated with a data analysis pipeline, wherein the data analysis pipeline is an unsupervised learning pipeline based on clustering, topic modeling, and large language models that enable generation of reasoned knowledge graphs based on a plurality of graph-based reasoning and inference agents that execute induction and deduction loops.

15. One or more computer-storage media having computer-executable instructions embodied thereon that, when executed by a computing system having a processor and memory, cause the processor to perform operations, the operations comprising:
accessing a data instance comprising data items, wherein the data instance is associated with a dataset;
using one or more unsupervised clustering techniques, generating a plurality of instructive clusters associated with the data instance;
using a topic modeling technique, generating a topic annotation of the plurality of instructive clusters;
using one or more Large Language Models (LLMs) and the plurality of instructive clusters with topic annotations, generating a plurality of annotated clusters, wherein an annotated cluster comprises a category annotation and a summary annotation;
using the plurality of annotated clusters, generating a first data analysis pipeline output comprising a first data instance assessment;
generating a filtered plurality of instructive clusters based on filtering the plurality of instructive clusters using a filtering criteria comprising a representative data feature parameter;
using a plurality of artificial intelligence (AI) agents and the filtered plurality of instructive clusters, generating a reasoned knowledge graph;
using the reasoned knowledge graph, generating a second data analysis pipeline output comprising a second data instance assessment; and
using the first data analysis pipeline output and the second data analysis pipeline output, generating a merged data analysis pipeline output.

16. The media of claim 15, wherein the one or more unsupervised clustering techniques include Hierarchical Density-Based Spatial Clustering of Applications with Noise (HDBSCAN) clustering and Spherical k-means clustering, the one or more unsupervised clustering techniques are executed on reduced data item embeddings associated with dimensionality reduction using Uniform Manifold Approximation and Projection.

17. The media of claim 15, wherein the topic modeling technique is based on a class-based TF-IDF (Term Frequency-Inverse Document Frequency) matrix and seed words that are representative of a data features to be extracted from the plurality of instructive clusters, wherein a topic annotation is a top word assigned to an instructive cluster, the top word summarizing subject matter encapsulated within its contents.

18. The media of claim 15, wherein generating the reasoned knowledge graph is based on an induction-deduction technique associated with executing iterative loops and refinements for continuous learning and validation.

19. The media of claim 15, wherein the plurality of AI agents are based on Reflexion agents and Reversible Jump Markov Chain-LLM.

20. The media of claim 15, wherein the merged data analysis pipeline output is associated with a data analysis pipeline, wherein the data analysis pipeline is an unsupervised learning pipeline based on clustering, topic modeling, and LLMs that enable generation of reasoned knowledge graphs based on a plurality of graph-based reasoning and inference agents that execute induction and deduction loops.
